(19) United States
(12) Patent Application Publication
(10) Pub. No.: US 2006/0080299 A1
(43) Pub. Date: Apr. 13, 2006

(54) Classification support apparatus, method, and recording medium in which classification support program is stored

(75) Inventors: Yumiko Shimogori, Kawasaki-shi (JP); Yasutaka Oodake, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/219,690

(22) Filed: Sep. 7, 2005

(30) Foreign Application Priority Data
Sep. 28, 2004 (JP) 2004-282056

(51) Int. Cl. G06F 17/30

(52) U.S. Cl. 707/3

(57) ABSTRACT

A classification support apparatus includes an input device inputting record data for each of organizations, the record data each belonging to a class item of class items and having property data corresponding to properties, respectively, an extraction device extracting a characteristic of each property data from each record data for each of the properties to acquire characteristics corresponding to the property data, a classification device classifying the properties into unified property items of the class item based on similarity between the characteristics of the property data among the record data to obtain a first classification result, a display device displaying the first classification result, a correction device correcting selectively the displayed first classification result according to correction request of a user to obtain a second classification result, and a memory storing the first and second classification results.

### CROSS-REFERENCE TO RELATED APPLICATIONS

This application is based upon and claims the benefit of priority from prior Japanese Patent Application No. 2004-282056, filed Sep. 28, 2004, the entire contents of which are incorporated herein by reference.

### BACKGROUND OF THE INVENTION

1. Field of the Invention

The present invention relates to construction of a schema of a hierarchical database.

2. Description of the Related Art

In a case where a plurality of organizations such as corporations gather to prepare a database having a common schema (classes and properties of the classes), in order to determine classes or properties, a specialist in database or modeling asks opinions of a domain specialist who belongs to each organization, to prepare the database top down.

In recent years, tools have been developed which support schema mapping by Extensible Markup Language (XML). These tools only visually support combining of tag names, and do not newly prepare common classes. Even by the use of these tools, the domain specialist of each organization still has to adjust the tools one by one in order to check association between properties.

In Jpn. Pat. Appln. KOKAI Publication No. 8-249338, it is described that in order to unify the schema, similarity is judged with respect to the property names of a database which have heretofore been used by the corporation to thereby support schema integration.

Terms or management methods which have heretofore been used by the respective organizations are different, or the terms of the domain specialist are different from those of the modeling specialist. Therefore, a terms adjustment, which is not essential is required in schema design. Even once the schema design is completed, problems are found in actually inputting data, in that case the schema design sometimes has to be done again.

As to the property names which have been used by the respective organizations, when conceptually similar names are used such as “heaviness”, “gravity”, “weight”, mapping using the property names is sufficient as described in Jpn. Pat. Appln. KOKAI Publication No. 8-249338. The property name is sometimes insufficient for performing mapping as in a case where a property name that does not have any concept is used like “w1” as a schema name.

As described above, there has heretofore been a problem that the property of which the name is different, but the same cannot be easily detected with high precision from record data made in each organization.

### BRIEF SUMMARY OF THE INVENTION

An object of the present invention is to provide a classification support apparatus and method in which different property names are used among a plurality of record data made in each organization, but the same property can be easily detected with high precision.

An aspect of the invention provides a classification support apparatus comprising: an input device configured to input a plurality of record data for each of a plurality of organizations, the plurality of record data each belonging to a class item of a plurality of class items and having a plurality of property data corresponding to a plurality of properties, respectively; an extraction device configured to extract a characteristic of each of the property data from each of the record data for each of the properties to acquire a plurality of characteristics corresponding to the plurality of property data; a classification device configured to classify the properties into a plurality of unified property items of the class item based on similarity between the characteristics of the property data among the record data to obtain a first classification result; a display device configured to display the first classification result; a correction device configured to correct selectively the displayed first classification result according to correction request of a user to obtain a second classification result; and a memory which stores the first classification result failed to be corrected and the second classification result.

### BRIEF DESCRIPTION OF THE SEVERAL VIEWS OF THE DRAWING

FIG. 1 is a diagram showing a constitution example of a classification support system;

FIGS. 2A, 2B and 2C are diagrams showing examples of record data classified by organizations for use as sample data classified by class items;

FIGS. 3A, 3B and 3C are diagrams showing record data having comparable forms;

FIG. 4 is a flowchart showing a process operation of a preprocessing unit;

FIG. 5 is a diagram showing one example of format mapping information;

FIG. 6 is a flowchart showing a process operation of a property characteristic extraction unit;

FIG. 7 is a flowchart showing a process operation of an instance set comparison unit;

FIGS. 8A and 8B are diagrams showing examples of basic information;

FIG. 9 is a diagram showing an example of property characteristic information;

FIG. 10 is a diagram showing an example of correspondence property information;

FIG. 11 is a flowchart showing a process operation of a property candidate presentation unit;

FIG. 12 is a diagram showing display examples of a plurality of property items obtained in accordance with class item, and a classification result of each property of sample data classified by property items;

FIG. 13 is a diagram showing one example of enumeration type data correspondence information;

FIG. 14 is a flowchart showing a process operation of a conversion program production unit;

FIG. 15 is a diagram showing one example of a template of a conversion program;

FIG. 16 is a diagram showing one example of the conversion program;

FIG. 17 is a flowchart showing a process operation of a class proposal unit;

FIG. 18 is a diagram showing one example of a class system;

FIG. 19 is a flowchart showing a process operation of a division proposal unit;

FIG. 20 is a diagram showing a process operation of the division proposal unit;

FIG. 21 is a flowchart showing an outline of a process operation of the whole classification support system;

FIG. 22 is a flowchart showing an outline of a process operation of the whole classification support system; and

FIG. 23 is a flowchart showing a process operation of a contents registration unit.

### DETAILED DESCRIPTION OF THE INVENTION

An embodiment of the present invention will be described hereinafter with reference to the drawings.

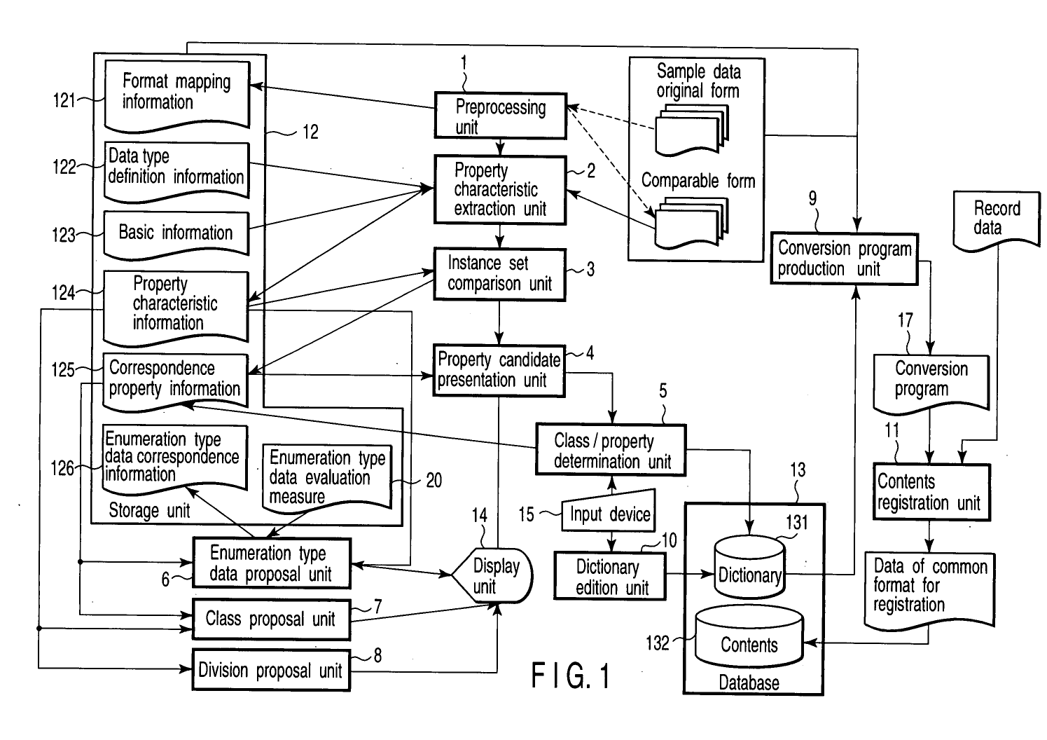

As shown in FIG. 1, according to an embodiment of the present invention, a classification support system comprises a preprocessing unit 1, a property characteristic extraction unit 2, an instance set comparison unit 3, a property candidate presentation unit 4, a class/property determination unit 5, an enumeration type data proposal unit 6, a class proposal unit 7, a division proposal unit 8, a conversion program production unit 9, a dictionary edition unit 10, a contents registration unit 11, a storage unit 12, and a database 13.

When components and products belonging to a certain class item are represented by a plurality of property data concerning the components and products, in most cases, even the property data of the same property have different property names for each organization such as company and department. When the organization differs, a recording form of property data concerning each component and product belonging to the class item, that is, the form of record data also differs with each class item.

In the classification support system shown in FIG. 1, each contents data is stored/managed for each component/product including a plurality of property data in accordance with each record data classified by class items for each organization, for example, the company, department, or branch. Among a plurality of property data, the property data of the same property is integrated as property data of the property item (e.g., property item provided with an identifier such as a basic semantic unit [BSU]) unified in all organizations in the class item. Moreover, the system performs a support for one-dimensionally managing the property data of the contents data in accordance with one unified form, and a support for producing one class system (having a hierarchical structure).

Therefore, first, as to a certain class item, record data are used as sample data having different forms for the respective organizations. Each property of the record data for each organization is classified into one of a plurality of class items for classifying each property based on characteristics of the property data of the respective properties included in each record data. In this case, even when the property name differs in each record data, a property having a similar characteristic is detected. That is, the property is detected which can be regarded as the same property. Moreover, the same property is classified into the same property item. It is to be noted that when the same property is not detected from another record data with respect to the property of certain record data, the property is also classified into one property item.

Thus, a plurality of property items are obtained which are unified with respect to the class item in all the organizations in order to classify the respective properties of a plurality of record data classified by class items or organizations. Moreover, the respective properties are classified into one of the plurality of property items, and a result is presented to a user.

The preprocessing unit 1 converts an original form of the record data which has been input as the sample data for each organization into a form capable of mutually comparing the property data included in the contents data in each record data.

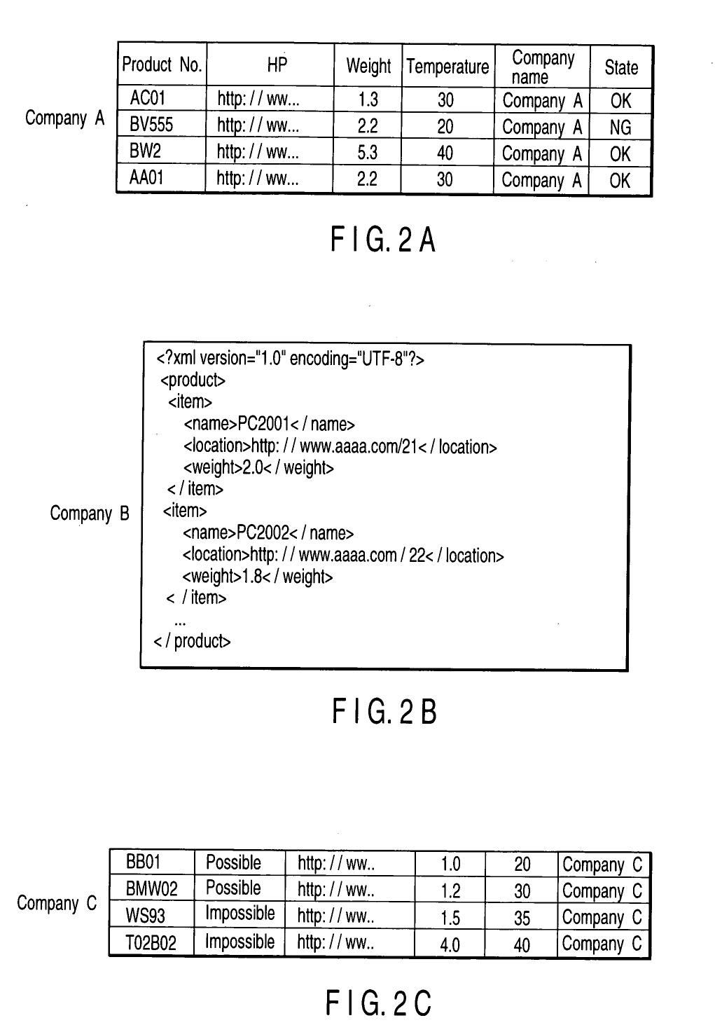

FIGS. 2A to 2C show examples of sample data which belongs to a class item “thermometer”, and show examples of the record data used by three organizations: companies A, B, and C, respectively. As shown in FIG. 2A, the record data of company A has a table form, and the property data included in the record data has property names of “product No.”, “HP”, “weight”, “temperature”, “company name”, and “state”. As shown in FIG. 2B, the record data of company B has an XML form, and each property data included in the record data has property names “name”, “location”, “weight” which are described as tag names. As shown in FIG. 2C, the record data of company C has a table form. The record data includes four contents data, each of data has six property data, and each property data does not have any property name.

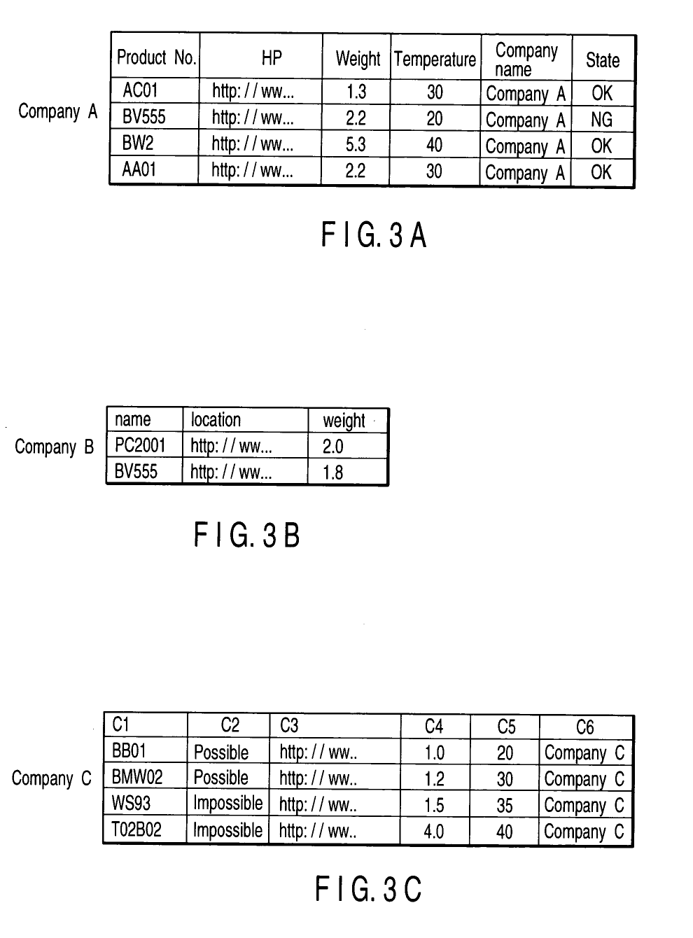

The preprocessing unit 1 converts an original form of the record data into a comparable form in such a manner that the property data of each record data can be easily compared among three organizations. Here, for example, it is assumed that the form of each record data is converted into a table form. FIGS. 3A to 3C show results of conversion of the record data shown in FIGS. 2A to 2C into a comparable form (table form).

As shown in FIGS. 3A to 3C, in the comparable form, a table form is constituted in which the property names (tag names) are described in a first line, and in second and subsequent lines, the property data (instances) are described which correspond to the respective property names (tag names) of the first line. Moreover, since each property data does not have any property name in the record data of FIG. 2C, the respective property data are provided with property names “C1” to “C6” in the record data of the comparable form of FIG. 3C.

It is to be noted that here the table form is described as an example of the comparable form, but the present invention is not limited to this example, and any form may be used as long as it is possible to compare the characteristics of the property data of the contents data included in each record data.

Moreover, the original form of each record data classified by class items and organizations may be a common separated value (CSV) form or a Hypertext Markup Language (HTML) document in addition to the table form or the Extensible Markup Language (XML) document as described above.

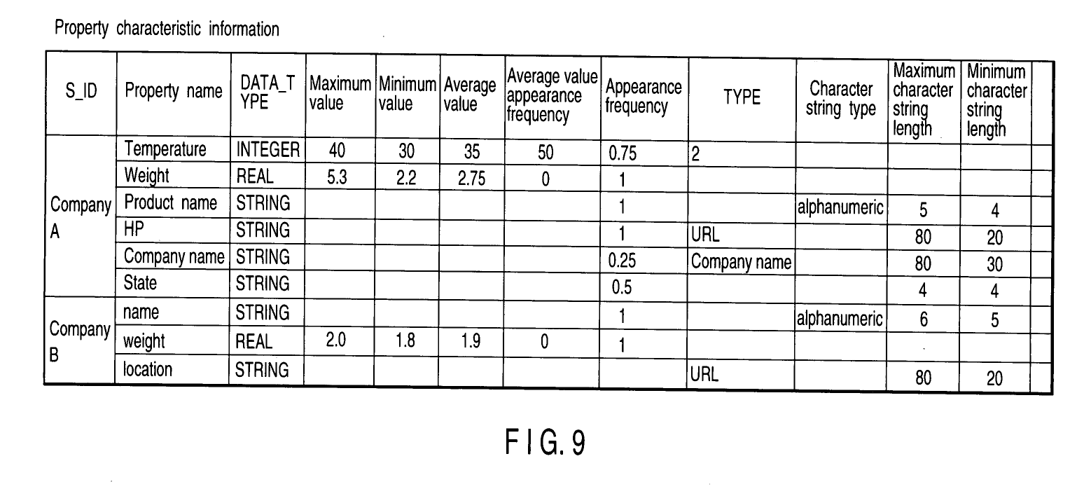

In the classification support system of FIG. 1, the property characteristic extraction unit 2 extracts characteristics (data type [character type, numerical type], URL, company name, digit number, numerical range, etc.) of each property data using each record data converted into the comparable form by the preprocessing unit 1 (see FIG. 9).

The instance set comparison unit 3 compares the characteristics of the property data of each property among different record data, obtains a plurality of property items for classifying the respective properties of the plurality of record data based on similarity of the characteristics of the property data, and classifies the respective properties into one of the plurality of class items. In this case, the instance set comparison unit 3 detects the same property among the plurality of record data based on the similarity of the characteristics of characteristic data classified by properties among the plurality of record data, and the unit classifies the same property into the same property item. Each property item is provided with an identifier (e.g., an identifier such as a BSU) for identifying each item, and correspondence property information is obtained as shown in FIG. 10.

As shown in FIG. 12, the property candidate presentation unit 4 displays in a display unit 14 each property item obtained with respect to the class item to which input sample data belongs, and a result of classification of each property of each record data in accordance with property item.

As shown in FIG. 12, the display unit 14 displays property candidates (each property item and classification result classified by property items). Thereafter, a user confirms this property candidate. If there is not any correction, the user operates an input device 15 such as a keyboard and a mouse to input a “determine” instruction into the class/property determination unit 5 with respect to the property candidate displayed in the display unit 14. When there is the correction of the property item or the classification result classified by property items, the user operates the input device 15 to delete/add the property item or change a property item name (identifier) or the like. The user performs an operation to reclassify the property (property name) classified into a certain property item into another property item, and instructs the class/property determination unit 5 to correct the property item or the classification result by property item.

The class/property determination unit 5 receives the “determine” instruction or the correction instruction from the user to update the correspondence property information shown in FIG. 10. Moreover, the updated correspondence property information is registered in a dictionary data storage unit 131 of the database 13.

The enumeration type data proposal unit 6 detects a property having enumeration type data as the property data based on the correspondence property information updated by the class/property determination unit 5, and a characteristic amount of each property data obtained by the property characteristic extraction unit 2, and displays the property in the display unit 14.

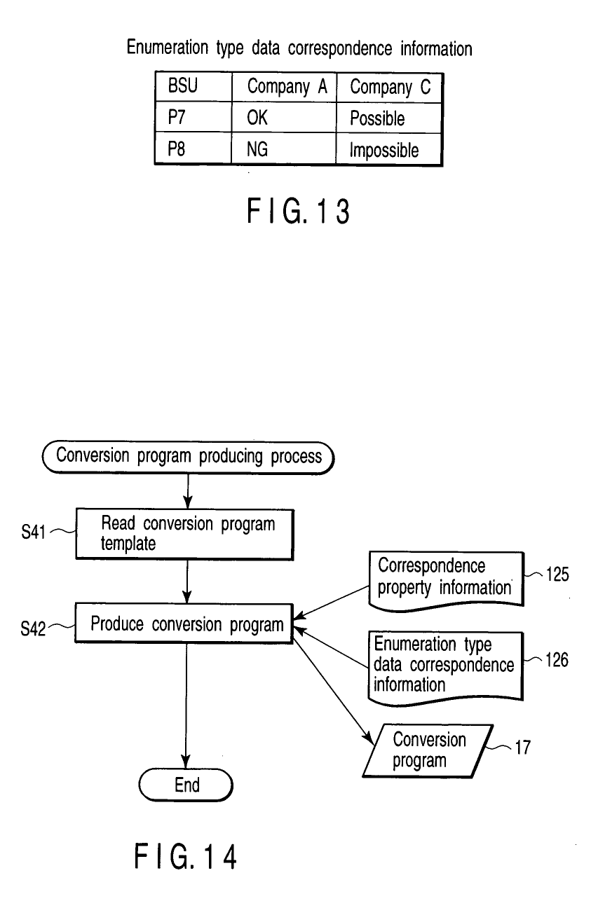

The display unit 14 displays a property item having the enumeration type data as the property data. Thereafter, the user operates the input device 15 to input into the class/property determination unit 5 a correspondence between data used in the same meaning in each record data classified into the property item. The enumeration type data proposal unit 6 gives the identifier (e.g., a BSU) with respect to each value which can be taken by the property item input by the user. Moreover, as shown in FIG. 13, enumeration type data correspondence information is produced, and displayed in the display unit 14.

As shown in FIG. 13, the enumeration type data correspondence information is displayed. Thereafter, the user confirms this information. If there is not any correction, the user operates the input device 15 to input the instruction “determine” into the class/property determination unit 5 with respect to the information displayed in the display unit 14. When there is the correction, the user operates the input device 15, and gives the correction instruction to the class/property determination unit 5.

The class/property determination unit 5 receives the instruction “determine” or the correction instruction from the user to update the enumeration type data correspondence information shown in FIG. 13. Moreover, the updated enumeration type data correspondence information is registered in the dictionary data storage unit 131 of the database 13.

By the dictionary edition unit 10, the user performs edition such as correction/addition or the like with respect to dictionary data registered in the dictionary data storage unit 131 of the database 13.

The conversion program production unit 9 produces a conversion program classified by organizations and class items to convert each property data of the record data classified by organizations and class items into the property data classified by property items of the class item, using the correspondence property information or the enumeration type data correspondence information registered in the dictionary data storage unit 131 as shown in FIGS. 10, 13.

The contents registration unit 11 converts each property data of the record data which belongs to the class item from the organization into the property data classified by property items of the class item using a conversion program 17 classified by organizations and class items, which has been produced by the conversion program production unit 9. Furthermore, the contents registration unit 11 converts the data into data of a common format for registration, and registers the data in a contents data storage unit 132 of the database 13.

The class proposal unit 7 detects a common property item of a plurality of class items based on the characteristic of each property data included in the sample data from each organization. The common property item is owned by each of the plurality of class items, and required for producing the class item of a higher class of the plurality of class items. The class proposal unit 7 displays in the display unit 14 the detected common property item and the plurality of class items having the shared property item. Moreover, the class proposal unit 7 informs the user that it is possible to produce the class item of the upper class of the plurality of class items.

Based on the characteristic of each property data included in the sample data from each organization, the division proposal unit 8 detects another class item that has the same property item as that owned by one of the plurality of class items. The division proposal unit 8 displays in the display unit 14 the two detected class items and the property item common to the two class items.

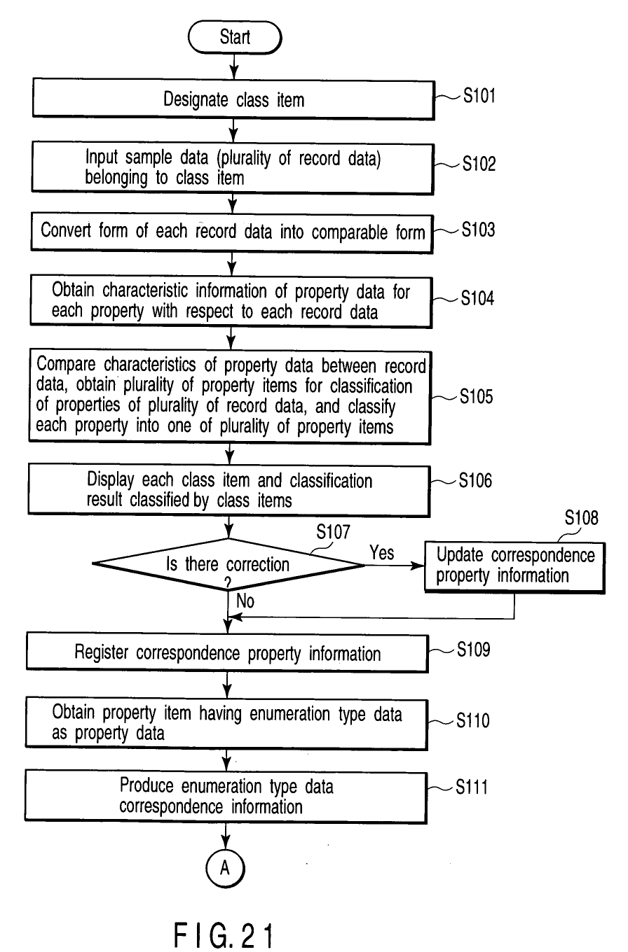

FIGS. 21 to 23 are flowcharts showing the whole process operation of the class construction support system of FIG. 1. An example of the process operation of each of the units will be described in a case where the record data of companies A to C shown in FIG. 2 are used as the sample data with reference to the flowcharts shown in FIGS. 21 to 23.

(Preprocessing Unit)

First, the user indicates an arbitrary class item (e.g., “clinical thermometer” is indicated here) to the preprocessing unit 1 (step S101). Moreover, the user inputs into the preprocessing unit 1 the sample data which belongs to the class item as shown in FIG. 2 (step S102). The preprocessing unit 1 converts the original form of the record data of each organization, input as the sample data, into a form capable of mutually comparing the property data included in the contents data in each record data (step S103).

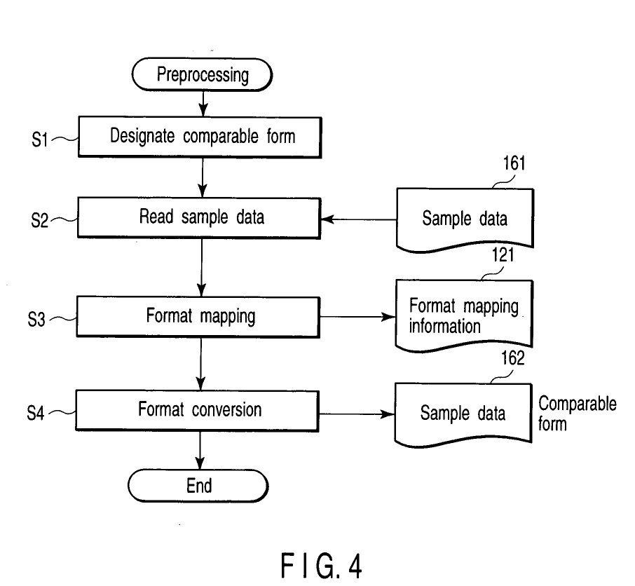

FIG. 4 is a flowchart showing the process operation of the preprocessing unit 1, which corresponds to step S103 of FIG. 21.

First, the user selects the comparable form which is a target with respect to the preprocessing unit 1 (step S1). Here, for example, the user selects the table form. The preprocessing unit 1 reads the sample data (step S2), and supplies to the user a GUI for converting the form (source) of each record data read as the sample data into the selected comparable form (table form).

It is to be noted that here the property name of the property data of each contents data included in the record data is written in each cell of a first line of a table of the target. In each of second and subsequent lines, the property data of each contents data included in the record data is written corresponding to each property name of the first line. Each row has a form including the property data having the same property name in each contents data included in the record data.

The user gives an instruction using the GUI in such a manner as to assign the property name of each property data of the record data which is the source to each cell of the first line of the table of the target, and assign the property data (instance) of each contents data included in the record data to the second and subsequent lines of the table of the target.

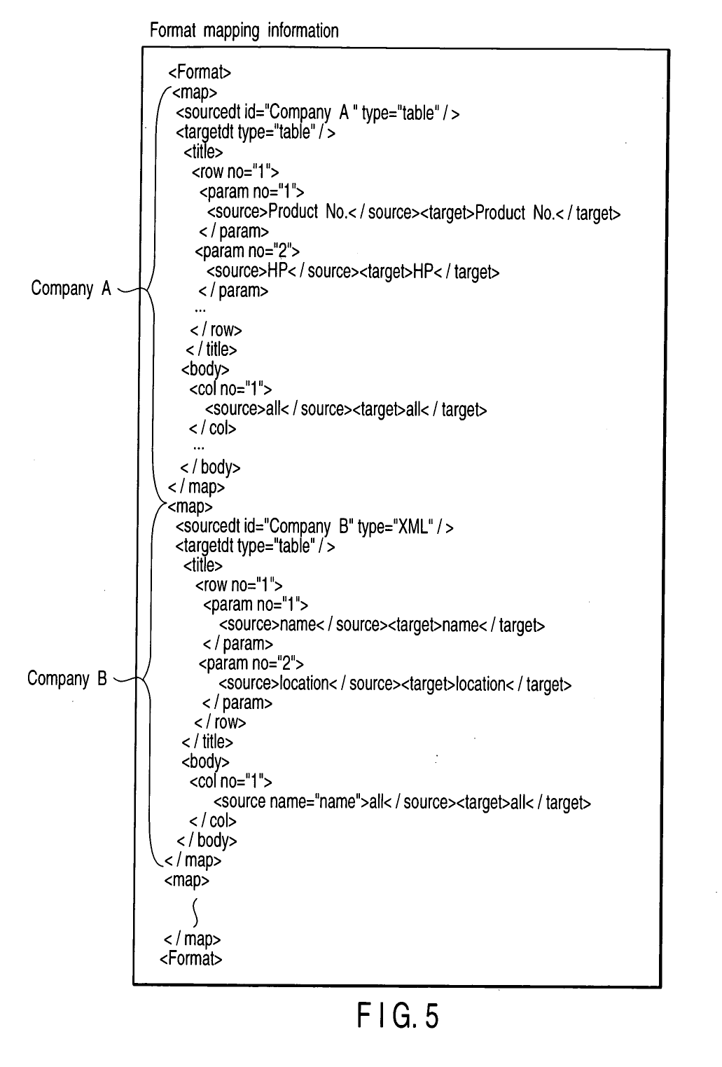

For example, the record data of FIG. 2A has a table form. In this case, the preprocessing unit 1 assigns the data in each class of the first line of the source table to each cell of the first line of the target table, and assigns the data in each cell of the second and subsequent lines of the source table to the second and subsequent lines of the target table. Moreover, the preprocessing unit 1 produces format mapping information corresponding to the A company as shown in FIG. 5 (step S3).

The format mapping information indicates the part of the source record data, which is to be assigned to each cell in the target table, and the information is stored in the storage unit 12 of FIG. 1.

The record data of FIG. 2C also has a table form. In this case, there is no column in which the property name is described. There, when the user gives an instruction in such a manner as to assign the data of each cell of the first and subsequent lines of the source table to the second and subsequent lines of the target table, the preprocessing unit 1 assigns a tentative property name (here “C1” to “C6”) to each cell of the first line of the target table, and produces the format mapping information corresponding to company C.

The record data of FIG. 2B has an XML form. In this case, the property names are tags “name”, “location”, “weight” in each element “item”. Therefore, the user gives an instruction in such a manner as to assign these tags to the respective cells of the first line of the target table. The user also gives an instruction in such a manner as to assign a value surrounded with these tags in the source record data to the second and subsequent lines of the target table corresponding to the tag having the value. As a result, the preprocessing unit 1 produces the format mapping information corresponding to company B as shown in FIG. 5.

Next, the unit converts the form of each record data shown in FIGS. 2A to 2C, which is the sample data, into the comparable form (here, the table form) shown in FIGS. 3A to 3C using format mapping information 121 shown in FIG. 5 (step S4).

(Property Characteristic Extraction Unit)

Next, the property characteristic extraction unit 2 obtains characteristic information of the property data classified by properties with respect to (the table of) each record data (step S104).

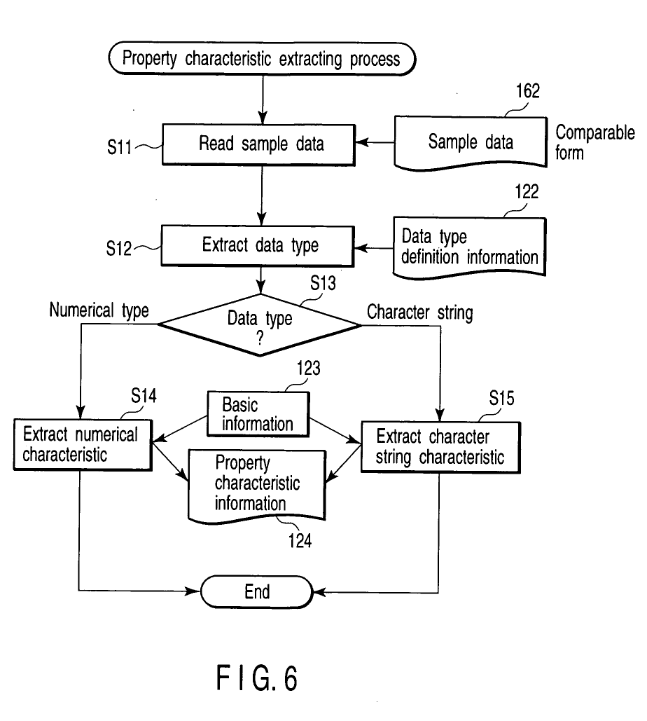

FIG. 6 is a flowchart showing a process operation of the property characteristic extraction unit 2 corresponding to step S104 of FIG. 21. The property characteristic extraction unit 2 performs the process shown in FIG. 6 to obtain, for example, property characteristic information having the table form as shown in FIG. 9. It is to be noted that the obtained property characteristic information is stored in the storage unit 12 of FIG. 1.

The property characteristic extraction unit 2 reads each record data of the comparable form shown in FIGS. 3A to 3C (step S11). Moreover, as to the table of the respective record data, the property characteristic extraction unit 2 obtains a data type of each row (the property data corresponding to the property name of the row) with reference to data type definition information 122 stored beforehand in the storage unit 12 (step S12).

The data type definition information 122 indicates a pattern of a data structure constituting the data type with respect to each of a character type (STRING), an integer type (INTEGER), and a real number type (REAL). The property characteristic extraction unit 2 checks whether or not each property data included in the row agrees with the pattern of the data type with respect to each row to judge the data type of the property data of each row.

When the data type of the property data is a numerical type (integer or real number) (step S13), the process advances to step S14. When the data type is a character type (step S13), the process advances to step S15.

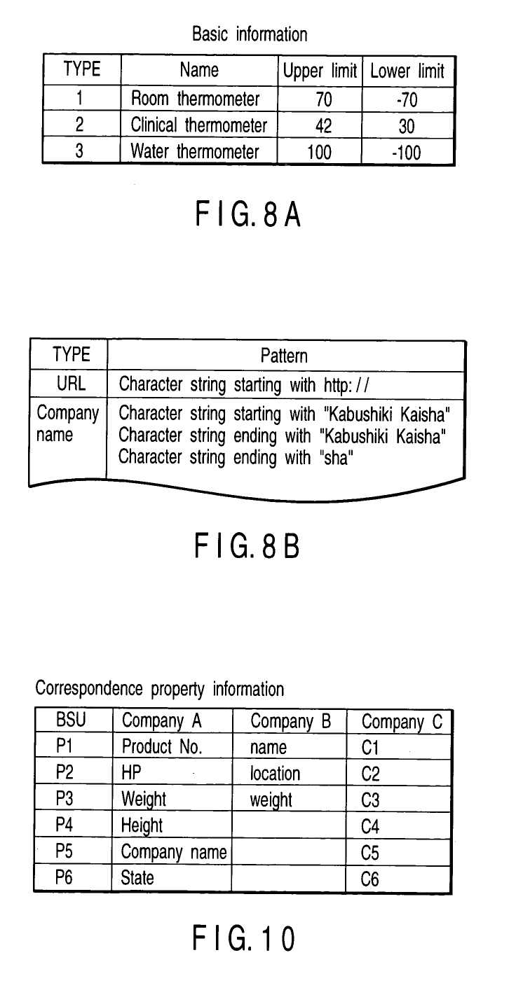

In step S14, characteristic amounts are obtained such as a minimum value, maximum value, average value, and appearance frequency of the property data with respect to the property of the row which is judged to be of a numerical type. Furthermore, the unit compares with each characteristic amount the basic information (stored beforehand in the storage unit 12 of FIG. 1) shown in FIG. 8, indicating the characteristic of the property data that can be included in the record data belonging to the class item like various standard values concerning a component/product or the like belonging to the class item of the sample data. Moreover, if there is a row (property) having a characteristic which agrees with or is similar to the characteristic of the basic information, it is judged that each property data of the row is a property indicated by the basic information. Moreover, the row (property) may be weighted which agrees with or is similar to the characteristic indicated by the basic information.

As shown in FIG. 9, for example, in the record data of company A of FIG. 3A, it is judged that the property data is of the integer type in the row having a property name “temperature”, and the property data is of the real number type in the row having a property name “weight”. Moreover, as to the property data of the “temperature” row, the minimum value is, for example, “30”, the maximum value is, for example, “40”, and the average value is, for example, “35”. In the record data of company A, the number of appearances of this average value (average value appearance frequency) is, for example, “50” here. The appearance frequency indicates the number of types of the value which can be taken with respect to the total number of the property data of the row of the property name “temperature”, and the frequency is, for example, “0.75”.

The basic information shown in FIG. 8A shows standard values of upper and lower limits in a measurement temperature range with respect to room, clinical, and water thermometers and the like. According to the basic information, in the clinical thermometer, an upper-limit value is 42 degrees, and a lower-limit value is 30 degrees. On the other hand, as to the “temperature” property shown in FIG. 9, the minimum and maximum values fall within the measurement temperature range of the clinical thermometer. Additionally, as compared with any other basic information, the values are closest to the upper and lower-limit values of the “clinical thermometer”. Therefore, the property characteristic extraction unit 2 judges that the “temperature” property relates to the temperature of the clinical thermometer. Moreover, as shown in FIG. 9, the property characteristic extraction unit 2 writes into a characteristic amount “TYPE” of the “temperature” property a value “2” of the “TYPE” column of the basic information corresponding to the clinical thermometer in the basic information of FIG. 8A.

In step S15, the property characteristic extraction unit 2 obtains characteristic amounts such as a character string length (maximum and minimum) and character string type with respect to each property data of the row which is judged to be of the character type. Furthermore, as described in step S14, the unit compares the respective characteristic amounts with the basic information shown in FIG. 8 relating to the component/product belonging to the class item of the sample data. Moreover, when there is a row (property) having the characteristic which agrees with or is similar to the characteristic of the basic information, each property data of the row is judged to be the property indicated by the basic information. Moreover, the row (property) may be weighted which agrees with or is similar to the characteristic indicated by the basic information.

As shown in FIG. 9, for example, in the record data of the A company of FIG. 3A, the property data is of a character string type in rows having property names “product No.”, “HP”, “company name”, and “state”. Moreover, as to the property data of the “product No.” row, a maximum character string length is, for example, five characters, and a minimum character string length is, for example, four characters. The type of the character string is a combination of alphabetic and numeric characters, that is, “alphanumeric” type.

Moreover, as shown in FIG. 3A, the property data of the “HP” row is a character string which constantly starts with “http://”. On the other hand, the basic information shown in FIG. 8B indicates that the “character string starting with http://” is “URL”. Therefore, since the property data of the “HP” row agrees with the characteristic of the basic information shown in FIG. 8B, the property characteristic extraction unit 2 judges that the property data of the “HP” row indicates the “URL”, and writes a value “URL” described in the “TYPE” column in the basic information of FIG. 8B into the characteristic information “TYPE” of the “HP” property as shown in FIG. 9.

Moreover, as shown in FIG. 3A, the property data of the “company name” row is a character string which constantly ends with “sha”. On the other hand, the basic information shown in FIG. 8B indicates that the “character string ending with “sha” is the “company name”. Therefore, since the property data of the “company name” row agrees with the characteristic of the basic information shown in FIG. 8B, the property characteristic extraction unit 2 judges that the property data of the “company name” row indicates the “company name”, and writes a value “company name” described in the 37 TYPE” column in the basic information of FIG. 8B into the characteristic information “TYPE” of the “company name” property as shown in FIG. 9.

Furthermore, in the record data of the B company of FIG. 3A, the property data is of a character string type in the row having the property name “location”, the maximum character string length is, for example, 80 characters, and the minimum character string length is, for example, 20 characters. As shown in FIG. 3B, the property data of the row of the property name “location” is a character string which constantly starts with “http://”. Therefore, the property data of the “location” row agrees with the characteristic of the basic information shown in FIG. 8B, the property characteristic extraction unit 2 judges that the property data of the “location” row indicates the “URL”, and writes a value “URL” described in the “TYPE” column in the basic information of FIG. 8B into the characteristic information “TYPE” of the “location” property as shown in FIG. 9.

As shown in FIG. 8B, the basic information may include a pattern indicating characteristics such as a data structure classified by types or the like for judging the type of each property data of the record data.

It is to be noted that the characteristic information obtained from the property data of each row (property) of the table of the record data is not limited to the information shown in FIG. 9.

The process operation of the property characteristic extraction unit 2 has been described above.

(Instance Set Comparison Unit)

Next, the instance set comparison unit 3 compares the characteristic information classified by property data obtained with respect to each record data between the record data. Moreover, the instance set comparison unit 3 obtains a plurality of property items for classifying the respective properties of the plurality of record data, and classifies each property into one of the plurality of class items. In this case, the instance set comparison unit 3 detects the same property among the plurality of record data based on the similarity of the characteristic of the property data classified by properties among the plurality of record data, and classifies the same property into the same property item (step S105).

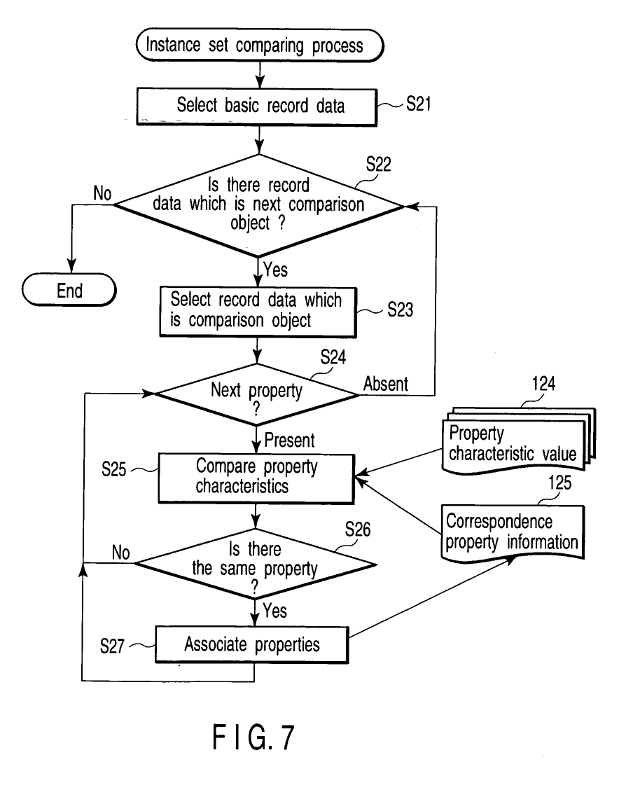

FIG. 7 is a flowchart showing a process operation of the instance set comparison unit 3 corresponding to the step S105 of FIG. 21. The instance set comparison unit 3 performs the process operation shown in FIG. 7 to thereby obtain, for example, the correspondence property information of the table form as shown in FIG. 10. The correspondence property information is stored in the storage unit 12 of FIG. 1.

First, the instance set comparison unit 3 selects standard record data from three record data which are sample data (step S21). Here, it is assumed that record data whose property number is largest is selected from these three record data. Therefore, the record data of company A is selected.

Next, the unit selects one (here, from the record data of companies B and C) of the record data (record data which is a comparison object) to be compared with the standard record data (steps S22, S23).

With regard to an arbitrary property of the record data which is the comparison object selected in step S23, the instance set comparison unit 3 compares the characteristic of the property data with that of each property of the standard record data. Moreover, the instance set comparison unit 3 obtains the property of the standard record data having a characteristic (regarded as the same as that of the arbitrary property) having a highest similarity with respect to the characteristic of the arbitrary property of the record data which is the comparison object. When a plurality of properties are obtained from the standard record data, the instance set comparison unit 3 selects one of them based on the similarity of the property name (steps S24, S25).

When the instance set comparison unit 3 obtains the property of the standard record data having the characteristic (regarded as the same as that of the arbitrary property) having a highest similarity with respect to the characteristic of the arbitrary property of the record data which is the comparison object (step S26), as shown in FIG. 10, the arbitrary property is associated with the property of the standard record data, which is judged to be the same as the arbitrary property, and is stored (step S27).

In step S25, the similarity of the standard record data to each property is calculated with respect to the characteristics like the data type, the character string type and the like of the arbitrary property of the record data which is the comparison object with reference to the property characteristic information shown in FIG. 9.

For example, the “name” property of the record data of company B will be described in a case where the characteristics of the property are compared with those of each property of the record data of company A selected as the standard record data.

As shown in FIG. 9, as to a “name” property of the record data of company B, a data type (DATA_TYPE) of the property data is of the character string type, the “character string type” is “alphanumeric”, the appearance frequency is “1”, the maximum character string length is “6”, and the minimum character string length is “5”.

Then, the instance set comparison unit 3 compares each characteristic information of the “name” property of the record data of company B with that of the arbitrary property of the record data of company A. When there is matched characteristic information, the similarity is set to “1” concerning the characteristic information. Moreover, as to the characteristic information represented by the numerical value, when the value does not agree, a ratio of the difference (difference between the characteristic information of the “name” property and the record data of the A company) with respect to the characteristic information of the “name” property is set as the similarity concerning the characteristic information. It is to be noted that when this ratio if not more than the predetermined threshold value, the similarity may be set to “0” concerning the characteristic information. In the case of the disagreement of the characteristic information indicating the type like the “DATA_TYPE” or the “character string type”, the similarity is set to “0” concerning the characteristic information. As to the certain property of the record data of the company A, after obtaining the similarity of each characteristic information to the “name” property of the record data of company B, a total value is calculated.

When there is not any “TYPE” characteristic information in the “name” property of the record data of company B, the total value of the similarity indicates the similarity between the “name” property of the record data of company B and the arbitrary property of the record data of company A.

When there is the “TYPE” characteristic information in the “name” property of the record data of company B, the weighting of a predetermined value is performed with respect to the total value of the similarity of the property having the “TYPE” characteristic information which agrees with that of the “name” property among the properties of the record data of company A. For example, the total value of the similarity is multiplied with a predetermined weight value (e.g., a positive integer value), and, as a result, an obtained value is set as the similarity between the “name” property of the record data of company B and the property of the record data of company A.

It is to be noted that a similarity which is higher than that of another characteristic information is assigned especially to the characteristic information representing the characteristic of the property most among the characteristic information concerning a certain property, or the weighting is performed otherwise in accordance with the importance of the characteristic information.

In this manner, the similarity between the properties indicates a high value, when there is more characteristic information (especially the characteristic information which is an important element in representing the characteristic of the property) whose values agree with each other or are close to each other. Additionally, when both “TYPE” characteristic information agrees with each other, any calculation method may be used as long as a higher value is indicated.

As shown in FIG. 9, as to the “product No.” property among the properties of the record data of the A company, the “DATA_TYPE” is “STRING”, the “character string type” is “alphanumeric”, and the appearance frequency is “1” in the same manner as in the “name” property of the record data of the B company. Moreover, the maximum and minimum character string lengths also indicate values almost equal to those of the “name” property of the record data of company B. Therefore, among the properties of the record data of company A, the “product No.” property has a highest similarity to the “name” property of the record data of company B.

Moreover, the “location” property of the record data of company B will be described, when compared with the characteristic of each property of company A record data selected as the standard record data.

As shown in FIG. 9, as to the property data of the “location” property of the record data of company B, the data type “DATA_TYPE” is a character string type, the “TYPE” is “URL”, the maximum character string length is “80”, and the minimum character string length is “20”.

Among the properties of the record data of company A, as to the “HP” property, the “DATA_TYPE” is “STRING”, and the “TYPE” is “URL” in the same manner as in information “location” property of the record data or company B. The maximum and minimum character string lengths also indicate values which are equal to those of the “location” property of the record data of company B. Therefore, the similarity of the “HP” property is highest among the properties of the record data of company A.

In this manner, as to the characteristic of the arbitrary property of the record data which is the comparison object, the instance set comparison unit 3 calculates the similarity to each property of the standard record data. As a result, the unit selects properties whose similarities are not less than a predetermined threshold value from the standard record data. The property having a highest similarity is selected from the properties. It is judged that the selected property is the same as the arbitrary property of the record data which is a comparison object.

It is to be noted that in a case where a plurality of properties are obtained whose similarities are not less than the predetermined threshold value and whose values are highest from the standard record data by the instance set comparison unit 3, as to the respective property names of the plurality of properties, the similarity is obtained with respect to the property name of the arbitrary property of the row which is the comparison object. Moreover, the property name is selected whose similarity is highest, and it is judged that the selected property is the same as the arbitrary property of the record data which is the comparison object.

Here, one example will be briefly described as to a method of calculating the similarity between the “property names”. A distance is obtained which corresponds to the similarity between the property names (vocabularies) in ontology, using an ontology dictionary (e.g., it is assumed that the dictionary is stored in the database 13 or the storage unit 12) indicating identity or similarity, lower/upper relation or the like of the meaning or concept between the respective vocabularies which are usable as the property names.

When the same property as the arbitrary property of the record data which is the comparison object is obtained from the standard record data in this manner (step S26), as shown in FIG. 10, both the properties are associated and stored (step S27).

After performing the process of steps S25 to S27 with respect to all the properties of the record data which is the comparison object (step S24), the process returns to step S22. When there is record data that has not been selected as the comparison object in the step S22, the process advances to step S23, unselected record data is selected, and the process of steps S24 to S27 is repeated. In step S22, the process of steps S23 to S27 is repeated until all the record data is selected except the standard record data as the comparison object.

As a result of the process shown in FIG. 7, the same properties are associated with one another among a plurality of record data, and classified into one property item. When the same property is not detected in the property of another record data, the property is classified as an element of one property item. That is, the correspondence property information is obtained as shown in FIG. 10, and classification results are obtained from a plurality of property items unified in all the organizations and the respective properties of the plurality of record data classified by property items with respect to the class item to which the input sample data belongs.

The instance set comparison unit 3 applies identifiers (here “P1” to “P6) to a plurality of property items of the class item as shown in FIG. 10.

(Property Candidate Presentation Unit)

In step S106 of FIG. 21, the property candidate presentation unit 4 displays a plurality of property items obtained with respect to the class item, and classification results of the respective properties of the sample data classified by property items.

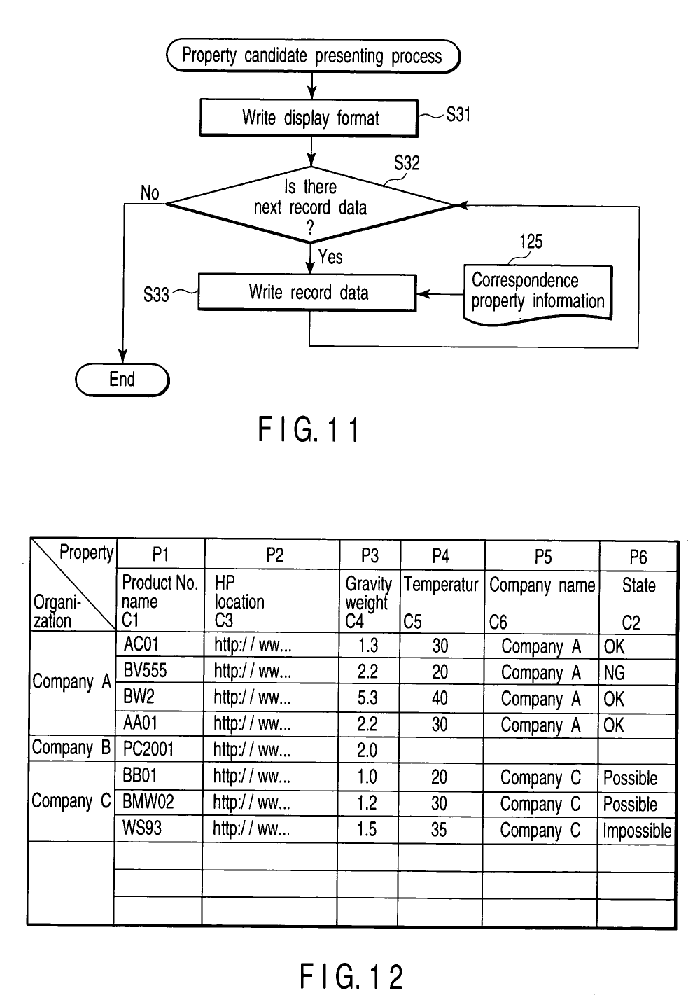

FIG. 11 is a flowchart showing the process operation of the property candidate presentation unit 4 in step S106.

First, a display format (e.g., a table form here) shown in FIG. 12 is displayed in the display unit 14 (step S31). At this time, with reference to the correspondence property information shown in FIG. 10, each property item, and the property name of each record data classified into the property item are displayed in each cell of the first line.

Next, each record data shown in FIG. 3 is successively read (step S32). With respect to each contents data included in each record data, each property data is displayed as shown in FIG. 12, while referring to the correspondence property information shown in FIG. 10 (step S33).

(Class/Property Determination Unit)

When property candidates shown in FIG. 12 (a plurality of property items, each property of the sample data classified by property items, and the classification result of each property data) are displayed in the display unit 14 as described above, the user confirms the property candidates. If there is not any correction, the user operates the input device 15 to input a “determine” instruction with respect to the property candidate displayed in the display unit 14 (step S107 of FIG. 21). If there is correction of the property item or the classification result classified by property items, the user operates the input device 15 to change a desired property item, or reclassify the property (property name) classified into a certain property item into another property item, and instructs the class/property determination unit 5 to correct the property item or the classification result classified by the property items (step S107 of FIG. 21).

The class/property determination unit 5 receives the “determine” instruction or the correction instruction from the user to update the correspondence property information shown in FIG. 10 (step S108 of FIG. 21). Moreover, the unit registers the updated correspondence property information (property item determined with respect to the class item to which the input sample data belongs (e.g., here the property items provided with the identifiers “P1” to “P6” and the classification result of each property (property name) of the sample data classified by the property items) in the dictionary data storage unit 131 of the database 13 (step S109 of FIG. 21).

(Enumeration Type Data Proposal Unit)

In the property characteristic information shown in FIG. 9, the “appearance frequency” characteristic information indicates the number of types of the value existing with respect to the total number of the property data of the property.

For example, when the total number of the property data is “250”, and there are two types of values: “male”; and “female”, the “appearance frequency” characteristic information is “ 2/250=0.008”. In the property characteristic information of FIG. 9, since the value of the property name “company name” is only one type which is “company A”, the information becomes “¼=0.25”.

An enumeration type data evaluation measure 20 stored beforehand in the storage unit 12 is a threshold value. When the appearance frequency is not more than (or is less than) the value, the property data is judged as the enumeration type data. It is assumed here that the enumeration type data evaluation measure is set to “0.5”. Therefore, properties are judged as the enumeration type data: a “P5” property including the “company name” property (appearance frequency is “0.25”) of the record data of company A and a “C6” property (appearance frequency is “0.25”) of the record data of the company C; and a “P6” property including the “state” property (appearance frequency is “0.5”) of the record data of the company A and a “C2” property of the record data of the company C.

The enumeration type data proposal unit 6 displays in the display unit 14 (the identifier of) the property item judged as the enumeration type data among a plurality of property items together with the property name or the property data of each record data classified into the property item (step S110 of FIG. 21). The user inputs a value which can be taken by the property data of each record data judged as the enumeration type data, and synonymous data. The enumeration type data proposal unit 6 gives the identifier to the synonymous data of each record data, and produces enumeration type data correspondence information shown in FIG. 13 (step S110 of FIG. 21). The produced enumeration type data correspondence information is stored in the storage unit 12.

For example, in the “P6” property, the record data of the company A has two types of property data: “OK”; and “NG”, and the record data of the company C has two types of the property data: “possible”; and “impossible”. In this case, when the user inputs information indicating that the “OK” of the record data of the company A is synonymous with the “possible” of the record data of the company C, the enumeration type data proposal unit 6 gives the identifier “P7” to the information. When the user inputs information indicating that the “NG” of the record data of company A is synonymous with the “impossible” of the record data of company C, the enumeration type data proposal unit 6 gives the identifier “P8” to the information.

It is to be noted that in steps S110 and S111 of FIG. 21, the enumeration type data proposal unit 6 may judge that the “OK” and “possible”, or the “NG” and “impossible” having high similarity are synonymous with each other based on the similarity corresponding to the distance between the vocabularies in the ontology, using the ontology dictionary (e.g., it is assumed that the dictionary is stored in the database 13 or the storage unit 12) indicating the identity, similarity, lower/upper relation or the like of the meaning or concept between the respective vocabularies for use as the property names.

Moreover, as shown in FIG. 13, the unit produces the enumeration type data correspondence information in which the synchronous data of each record data is associated with the identifier given to the synonymous data. In FIG. 13, for example, the “OK” of company A record data is associated with the “possible” of company C record data and the identifier “P7” given to these data. The “NG” of company A record data is associated and displayed with the “impossible” of company C record data, and the identifier “P8” given to these data. The enumeration type data correspondence information shown in FIG. 13 is displayed in the display unit 14.

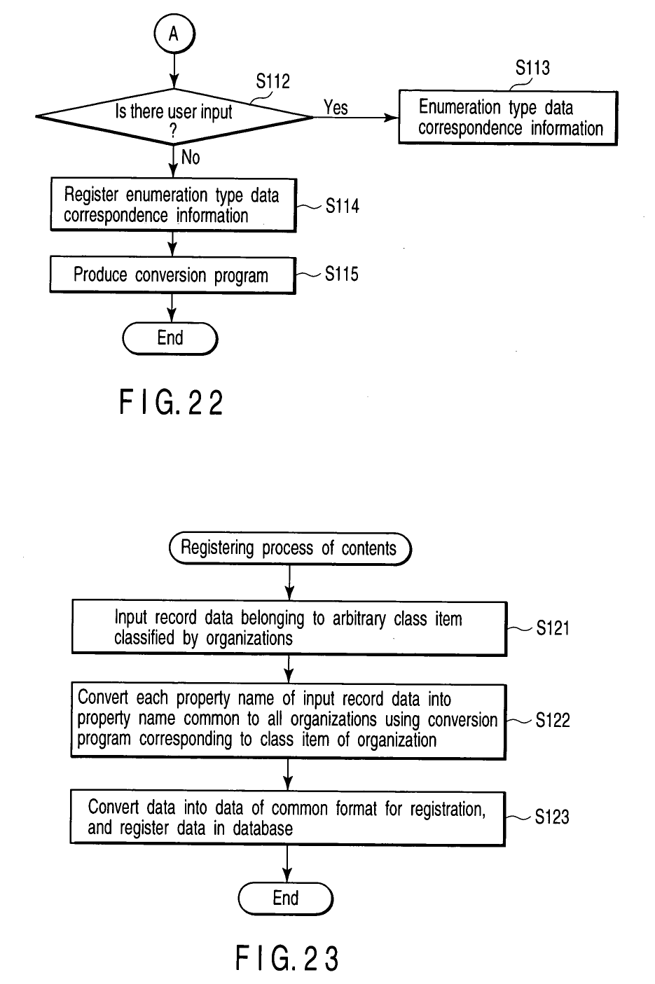

The user confirms this information. If there is not any correction, the user operates the input device 15 to input the “determine” instruction into the class/property determination unit 5 with respect to the information displayed in the display unit 14 (step S112 of FIG. 22). When there is the correction, the user operates the input device 15 to give the correction instruction to the class/property determination unit 5 (step S112).

The class/property determination unit 5 receives the “determine” instruction or the correction instruction from the user to update the enumeration type data correspondence information shown in FIG. 13 (step S113). Moreover, the enumeration type data correspondence information is registered in the dictionary data storage unit 131 of the database 13 (step S114).

(Conversion Program Production Unit)

In step S115 of FIG. 22, the conversion program production unit 9 produces the conversion program which converts each property data of the record data belonging to the class item from the organization into each property data classified by property items obtained in the class item in accordance with organization and class item. At this time, the conversion program production unit 9 uses the correspondence property information and the enumeration type data correspondence information registered in the dictionary data storage unit 131 and various other information stored in the storage unit 12. Here, as one example, the unit produces the conversion program which converts the property name of each property of each contents data included in the record data belonging to the class item from the organization into the identifier of the property item obtained with respect to the class item.

It is to be noted that this conversion program may include a program for converting the form of the record data belonging to the class item from the organization into a form which is common to all the organizations.

FIG. 14 is a flowchart showing a process operation of the conversion program production unit 9 in step S115.

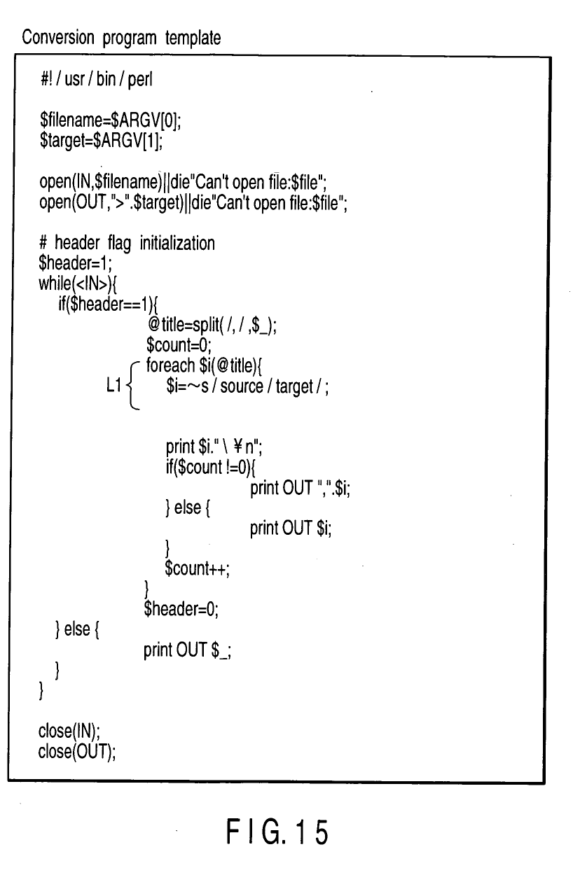

First, a template of the conversion program is read as shown in FIG. 15 (step S41). In the template shown in FIG. 15, the property name in the record data classified by organizations is substituted into an argument “source” of “$i= . . . s/source/target/;” which is a command sentence L1. Moreover, when substituting the identifier of the classified property item of the property into the argument “target”, the conversion program is completed which converts each property name of the record data classified by organizations and class items into the identifier of the property item corresponding to the property.

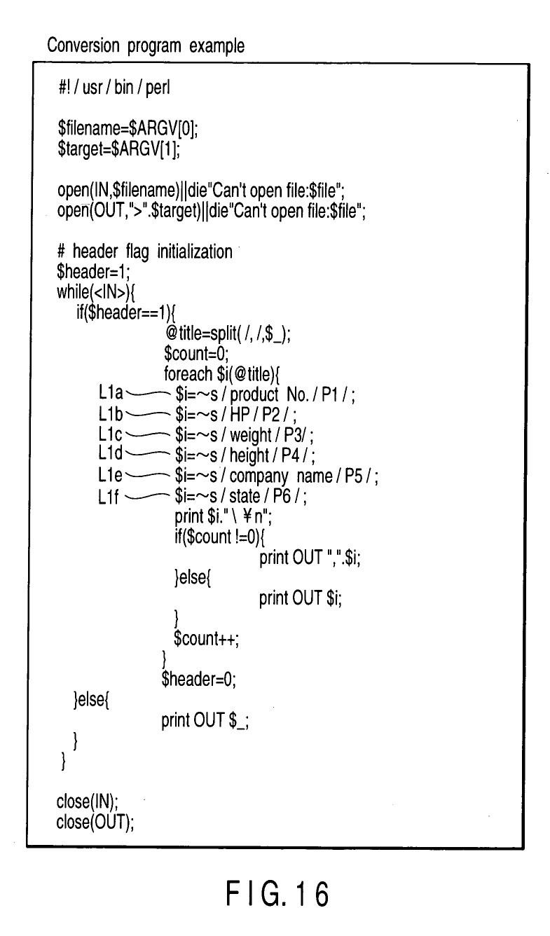

Here, an example will be described in which the conversion program is produced with respect to the class item “clinical thermometer” of company A. Since the record data of company A uses six property names “product No.”, “HP”, “weight”, “height”, “company name”, and “state”, the conversion program production unit 9 substitutes six property names into arguments “source” of six command sentences L1, respectively. Furthermore, the unit substitutes the identifiers “P1” to “P6” of the property items corresponding to the six property names into the arguments “target” of the six command sentences L1, respectively. As a result, the conversion program is produced as shown in FIG. 16 (step S42). In FIG. 16, L1a to L1f denote converted command sentences of the property name.

The conversion programs are similarly produced with respect to companies B and C.

The above-described steps S101 to S115 are a series of process operation using the input sample data with respect to one class item. When the process of steps S101 to S115 is repeated with respect to each class item, a plurality of property items can be obtained which are unified in all the organizations with respect to each class item.

(Contents Registration Unit)

As shown in FIG. 23, when each record data for registration for each organization is input (step S121), the contents registration unit 11 converts each property name of the record data belonging to the class item from the organization into the identifier of the property item corresponding to the property using the conversion program 17 classified by organizations/class items produced by the conversion program production unit 9 (step S122). Furthermore, the contents registration unit 11 converts the data into the data of the common format for the registration to register the data in the contents data storage unit 132 of the database 13 (step S123).

(Class Proposal Unit)

When the process of steps S101 to S115 is repeated with respect to each class item, it is possible to obtain a plurality of property items, and the results of the classification of the respective properties of the record data classified by organizations into the plurality of property items in accordance with class item.

For example, as to the class item “clinical thermometer” shown in FIG. 2, the property items “P1” to “P6” are obtained as shown by the correspondence property information of FIG. 10.

Moreover, for example, when the process of the above-described steps S101 to S115 is also performed, for example, with respect to a “water thermometer” which is another class item, it is assumed that property items “P11” to “P15” are obtained.

Furthermore, for example, when the process of the above-described steps S101 to S115 is also performed, for example, with respect to a “room thermometer” which is another class item, it is assumed that property items “P21” to “P25” are obtained.

When a plurality of property items owned by each class item are obtained with respect to a plurality of class items in this manner, the class proposal unit 7 extracts the common property item owned by each of the plurality of class items.

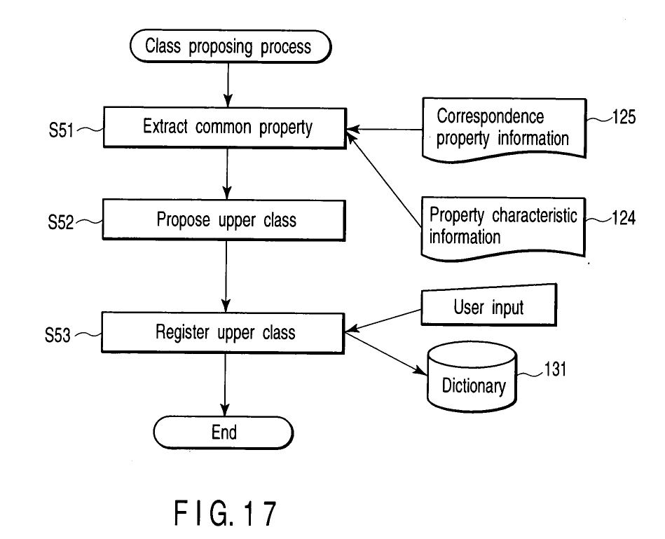

A process operation of the class proposal unit 7 will be described with reference to the flowchart shown in FIG. 17.

First, step S51 will be described. When the property names “P1” to “P6” are obtained with respect to the class item “clinical thermometer”, the property names “P11” to “P15” are obtained with respect to the class item “water thermometer”, and the property names “P21” to “P25” are obtained with respect to the class item “room thermometer” as described above, the property characteristic extraction unit 2 performs a process similar to that of the instance set comparison unit 3, using the property characteristic information obtained from the sample data of each class item as shown in FIG. 9. That is, the characteristic information of the property data of the respective properties is compared between the sample data of each class item to detect the same property.

For example, it is assumed that the characteristic information of the property data of the respective record data corresponding to the respective property names of “P1”, “P11”, and “P21” agree with or are similar to one another, and they are judged as the same property. It is also assumed that the characteristic information of the property data of the respective record data corresponding to the property names “P2”, “P12”, and “P22” agree with or are similar to one another, and they are judged as the same property. It is also assumed that the characteristic information of the property data of the respective record data corresponding to the property names “P3”, “P13”, and “P23” agree with or are similar to one another, and they are judged as the same property.

Here, for the sake of convenience, the property names of “P1”, “P11”, “P21” judged as the same property are assumed as “P1”, the property names of “P2”, “P12”, “P22” are assumed as “P2”, and the property names of “P3”, “P13”, “P23” are assumed as “P3”.

In step S51, since the property items “P1” to “P3” exist in any of the three class items, the class proposal unit 7 extracts these common property items “P1” to “P3”.

Moreover, in step S52, when the property items “P1” to “P3” are common to the above-described three class items, the display unit 14 displays information informing the user that the class item having the three common properties can be an upper class item of the three class items.

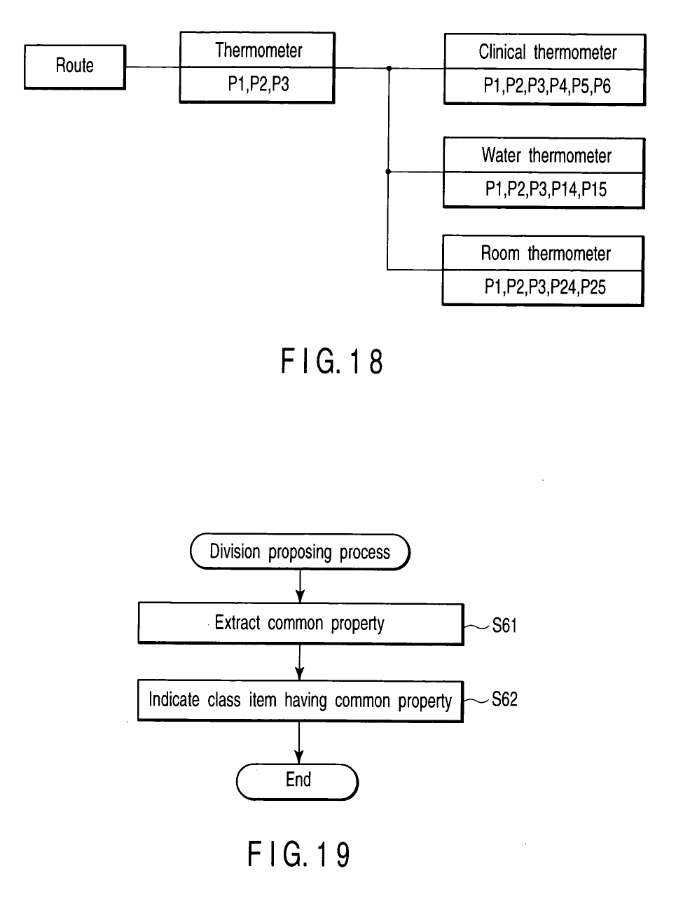

The user accepts, rejects or corrects and thereafter accepts that the class item having the properties “P1” to “P3” is set as the upper class item of the three class items. For example, after correcting the name or identifier of the upper class item, the property owned by the upper class item or the like, the user inputs “acceptance”. Then, as a result of the correction, a class system shown in FIG. 18 is obtained, and registered in the dictionary data storage unit 131 of the database 13 (step S53).

The class system (hierarchical structure of the class item) shown in FIG. 18 has a “thermometer” which is the upper class item of the class items “clinical thermometer”, “water thermometer”, and “room thermometer”. This class item is a class item having the common property item owned by any of three lower class items “P1” to “P3”.

(Division Proposal Unit)

FIG. 19 is a flowchart showing a process operation of the division proposal unit 8.

With respect to a plurality of class items, the division proposal unit 8 detects another class item having the same property item as that of one class item among the plurality of class items based on the characteristic of each property data included in the sample data from each organization (step S61).

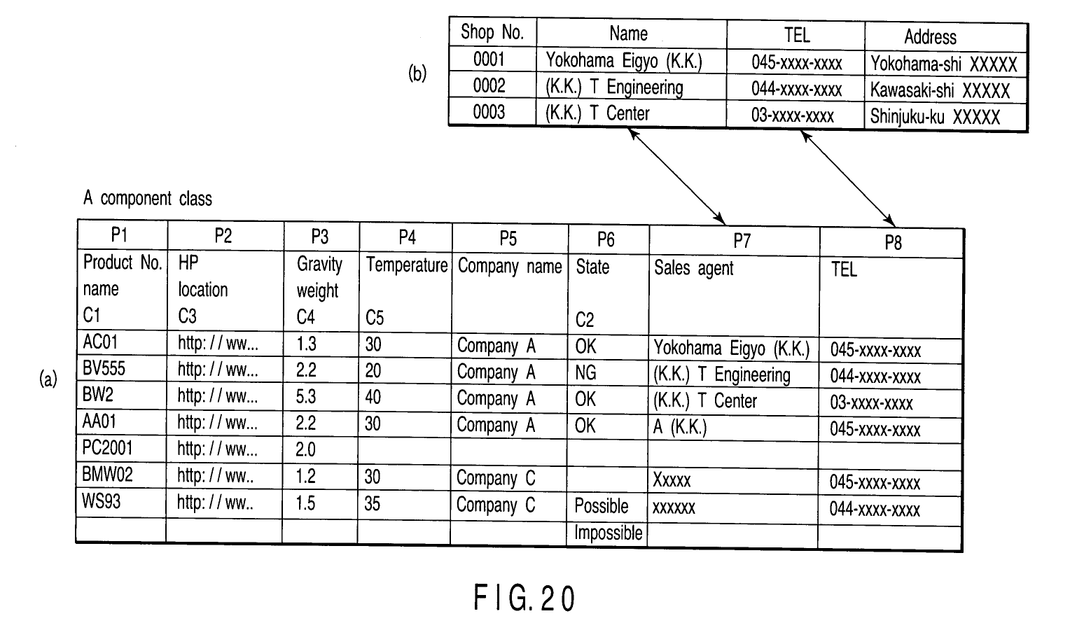

That is, the division proposal unit 8 performs a process similar to that of the instance set comparison unit 3 using the property characteristic information to check whether or not both the items have the same property. The property characteristic information includes: property characteristic information shown in FIG. 9 obtained with respect to each property data classified by property items of a certain class item as shown in FIG. 20(a); and property characteristic information shown in FIG. 9 obtained with respect to each property data corresponding to each property item of another class item as shown in FIG. 20(b).

When the same property exists in both the characteristics, that is, when two class items are detected having the common property item, the division proposal unit 8 displays in the display unit 14 two detected class items and the property item common to the two class items (step S62).

The user can delete the property item which has been judged to be the same as that of the class item shown in FIG. 20(b), for example, among the property items of the class item shown in FIG. 20(a) with reference to the information displayed in the display unit 14, or edit otherwise.

This edition is performed, for example, by the dictionary edition unit 10.

As described above, according to the above-described embodiment, a plurality of property items are obtained in accordance with class item based on the characteristic of the property data classified by properties of each record data classified by organizations, and each property of each record data is classified into one of the plurality of property items. Accordingly, different property names are used among a plurality of record data classified by organizations, but it is possible to detect the same property easily with high precision.

Moreover, when displaying the classification result classified by property items of each property of each record data, the system supports the user in such a manner as to perform one-dimensional management of the record data classified by organizations whose property name or form is not unified in accordance with the unified property item and form.

It is to be noted that each constituting unit (preprocessing unit 1, property characteristic extraction unit 2, instance set comparison unit 3, property candidate presentation unit 4, class/property determination unit 5, enumeration type data proposal unit 6, class proposal unit 7, division proposal unit 8, conversion program production unit 9, dictionary edition unit 10, contents registration unit 11 or the like) of the classification support system of FIG. 1 can be stored and distributed as a computer-executable program by means of recording mediums such as a magnetic disc (flexible disc, hard disc, etc.), an optical disc (CD-ROM, DVD, etc), and a semiconductor memory.

For example, storage means such as a memory of the computer or a hard disc is used as the storage unit 12 or the database 13 of FIG. 1, and computing means such as a CPU executes the process steps performed in each constituting unit of FIG. 1 as shown in FIGS. 21 to 23 or the like. Consequently, the classification support system described in the above-described embodiment can be realized by the computer. It is to be noted that the database of the class construction support system of the present invention may be constructed by ISO 13584 Parts Library (formal name of PLIB [International Standardization Organization: ISO]). The “property” corresponds to “attribute”, and the “class” corresponds to “node”.

According to the present invention, the different property names are used among a plurality of record data made in each organization, but the same property can be easily detected with a high precision. As a result, with respect to a user, it is possible to identify the record data made in each organization whose property names or forms are not unified, in accordance with unified property items and forms, and a common class system can be efficiently constructed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A classification support apparatus comprising:
an input device configured to input a plurality of record data for each of a plurality of organizations, the-plurality of record data each belonging to a class item of a plurality of class items and having a plurality of property data corresponding to a plurality of properties, respectively;
an extraction device configured to extract a characteristic of each of the property data from each of the record data for each of the properties to acquire a plurality of characteristics corresponding to the plurality of property data;
a classification device configured to classify the properties into a plurality of unified property items of the class item based on similarity between the characteristics of the property data among the record data to obtain a first classification result;
a display device configured to display the first classification result;
a correction device configured to correct selectively the displayed first classification result according to correction request of a user to obtain a second classification result; and
a memory which stores the first classification result failed to be corrected and the second classification result.

2. The classification support apparatus according to claim 1, wherein the classification device further comprises:
a detection device configured to detect a same property among the record data based on the similarity, and
a setting device configured to set the same property to the same unified property item.

3. The classification support apparatus according to claim 1, further comprising a converted program production device configured to produce a conversion program for each of the organizations and for each of the class items to convert each of the property data of the record data of each of the organizations into property data for each of the unified property items based on the classification result.

4. The classification support apparatus according to claim 1, wherein the memory stores the first classification result failed to be corrected and the characteristic of the property data extracted for each of the properties by the extraction device, with respect to each of the class items of the first classification result and the second classification result,
the apparatus further comprising another detection device configured to detect the same property item as that owned by any one of the plurality of class items based on the similarity.

5. The classification support apparatus according to claim 1, wherein the memory stores the first classification result and the characteristic of the property data extracted for each of the properties by the extraction device, with respect to each of the class items of the first classification result and the second classification result,
the apparatus further comprising another detection device configured to detect another class item having the same property item as that owned by one of the plurality of class items based on the similarity between the characteristics of the property data for each of the properties among the property items of the plurality of class items.

6. The classification support apparatus according to claim 1, further comprising another detection device configured to detect a property item having enumeration type data as the property data based on the characteristic of the property data extracted for each of the properties by the extraction device.

7. The classification support apparatus according to claim 3, further comprising:
a conversion device configured to convert each of the property data of the record data into a related one of the unified property items of the class item using the conversion program; and
a second memory configured to store each of the property data for each of the unified property items.

8. A classification support method comprising:
inputting a plurality of record data for each of organizations, the plurality of record data belonging to a class item of a plurality of class items and having a plurality of property data corresponding to a plurality of properties, respectively;
extracting a characteristic of each of the property data from the record data for each of the properties to acquire a plurality of characteristics corresponding to the plurality of property data; and
classifying the properties into a plurality of unified property items of the class item based on similarity between the characteristics of the property data for each of the properties among the record data to obtain a first classification result.

9. The classification support method according to claim 8, further comprising:
displaying the first classification result;
correcting selectively the displayed first classification result according to correction request of a user to obtain a second classification result; and
storing the first classification result failed to be corrected and the second classification result in a memory.

10. The classification support method according to claim 8, which further comprises detecting the same property among the plurality of record data based on the similarity, and
setting the same property into the same unified property item.

11. The classification support method according to claim 9, further comprising producing a conversion program for each of organizations and for each of the class items to convert each of the property data of the record data for each of the organizations into property data for each of the unified property items based on the first classification result.

12. The classification support method according to claim 9, wherein the storing memory stores the first classification result failed to be corrected and the characteristic of the property data extracted for each of the properties, with respect to each of the class items of the first classification result and the second classification result,
the method further comprising detecting the same property item as that owned by any of the plurality of class items based on the similarity in the property items of the plurality of class items.

13. The classification support method according to claim 9, wherein the storing includes storing the first classification result failed to be corrected and the characteristic of the property data extracted for each of the properties by the extracting step, with respect to each of the class items of the first classification result and the second classification result,
the method further comprising detecting another class item having the same property item as that owned by one of the plurality of class items based on the similarity in the property items of the plurality of class items.

14. The classification support method according to claim 8, further comprising detecting a property item having enumeration type data as the property data based on the characteristic of the property data extracted for each of the properties by the extracting.

15. The classification support method according to claim 11, further comprising:
converting each of the property data of the record data into a related one of the unified property items of the class item using the conversion program; and
storing each of the property data for each of the properties in a second memory.

16. A computer program stored in a computer readable medium, the program comprising:
means for instructing the computer to input a plurality of record data for each of organizations, the plurality of record data belonging to a class item of a plurality of class items and having a plurality of property data corresponding to a plurality of properties, respectively;
means for instructing the computer to extract a characteristic of each of the property data from the record data for each of the properties to acquire a plurality of characteristics corresponding to the plurality of property data;
means for instructing the computer to classify the properties into a plurality of unified property items of the class item based on similarity between the characteristics of the property data for each of the properties among the record data to obtain a first classification result;
means for instructing the computer to display the first classification result in a display;
means for instructing the computer to correct selectively the displayed first classification result according to correction request of a user to obtain a second classification result; and
means for instructing the computer to store the first classification result failed to be corrected and the second classification result in a memory.

17. The classification support program according to claim 16, wherein the classifying means further comprises first detecting means for instructing the computer to detect a same property among the plurality of record data based on the similarity, and
setting means for instructing the computer to set the same property to the same unified property item.

18. The classification support program according to claim 16, further comprising conversion program producing means for instructing the computer to produce a conversion program for each of organizations and for each of the class items to convert each of the property data of the record data for each of the organizations into property data for each of the unified property items based on the first classification result.

19. The classification support program according to claim 16, further including means for instructing the computer to store in the memory the first classification result failed to be corrected and the characteristic of the property data extracted for each of the properties, with respect to each of the class items of the first classification result and the second classification result; and,
means for instructing the computer to detect the same property item as that owned by any of the plurality of class items based on the similarity in the property items of the plurality of class items.

20. The classification support program according to claim 16, further including means for instructing the computer to store in the memory the first classification result failed to be corrected and the characteristic of the property data extracted for each of the properties by the extracting step, with respect to each of the class items of the first classification result and the second classification result; and,
means for instructing the computer to detect another class item having the same property item as that owned by one of the plurality of class items based on the similarity in the property items of the plurality of class items.
